(19) United States
(12) Patent Application Publication
(10) Pub. No.: US 2012/0222608 A1
(43) Pub. Date: Sep. 6, 2012

(54) METHOD OF FABRICATING PAD FOR SUPPORTING PORTION OF A VESSEL HULL

(76) Inventor: John J. Argitis, Sturbridge, MA (US)

(21) Appl. No.: 13/404,742

(22) Filed: Feb. 24, 2012

Related U.S. Application Data
(60) Provisional application No. 61/449,117, filed on Mar. 4, 2011.

(51) Int. Cl. B63B 17/00; B29C 45/00

(52) U.S. Cl. 114/343; 264/219

(57) ABSTRACT

In a method of fabricating a one-piece pad for supporting a portion of a vessel hull thereon, a product design for a mold is initially created in software. Creating the product design includes forming an upper planar surface portion with a plurality of ribs in spaced-apart relation there across and which extend substantially upward, the ribs serving as contact points to a surface portion of the vessel hull adapted to be supported by a structure supporting the to-be-formed one-piece pad thereon, forming a rear support ribbing portion representative of a bottom surface of the pad, and forming vertical sides between the upper planar surface portion with ribs and rear support ribbing portion. The method further includes forming a mold based on the created product design, mounting the mold on an injection molding machine, and forcing plastic materials into the mold on the machine to form the one-piece pad.

### CROSS-REFERENCE TO RELATED APPLICATIONS

The present application claims the benefit under 35 U.S.C. §119(e) of U.S. Provisional Patent Application No. 61/449,117 to the inventor, filed Mar. 4, 2011, the entire contents of which is hereby incorporated by reference herein. This application is related to U.S. Pat. No. 7,191,726 to the inventor, issued Mar. 20, 2007, the entire contents of which is hereby incorporated by reference herein.

### BACKGROUND

1. Field

Example embodiments generally relate to a method of fabricating a one-piece pad for supporting a portion of a vessel hull thereon.

2. Related Art

Conventionally, boat pads for boat stands and/or boat trailers have been constructed with a painted wood platform that is coated (i.e., dip painted). The painted wood surface typically does not provide sufficient protection to boat bottoms. For example, many racing sailboats have epoxy bottoms or bottoms having a wet sanded gel coat. The painted wood pads that contact the boat bottoms typically scratch and/or otherwise damage these boat bottom surfaces. Another problem with the use of wood pads is the limited life expectancy of the pads, since the nature of the material used lends itself to decay over a relatively short period of time and hence requires periodic repair and/or replacement.

In an effort to overcome these problems, boat owners, boat yards and trailer manufacturers have attempted to cover the wood pads with some type of indoor/outdoor carpeting. The problem with using carpeting is that the carpeting acts as a sponge, holding moisture against the boat hull and the wood pad itself. This typically causes the portion of the boat hull or bottom contacting the pad to blister over time, and can expedite the decay process of the wood pad. The replacement of the wood pads thus poses an expensive problem for boat owners and/or users.

Other conventional homemade solutions include gluing various foam strips to the wood pad or cutting up old doormats and gluing the doormat portions to the pads. None of these prior art methods effectively protect the boat bottoms from scratches, blemishes, rub marks and damage. Additionally, none of these prior art solutions effectively prolong the life of the pad itself, with some actually serving to reduce the life of the wood pad.

U.S. Pat. No. 7,191,726 to the inventor has addressed many of these shortcomings. The '726 patent describes a boat pad that includes a planar member composed of an elastomeric, rubber or like material that is physically attached to a separate, hard plastic backing plate. The planar member includes a plurality of spaced-apart raised features formed on its surface that are configured to contact a surface of a water vessel hull as the hull is being supported by a boat stand or boat trailer including the pad. However, water or moisture can still seep or get trapped between the pad and the backing plate, potentially causing wear and/or damage to the pad and/or backing plate over time if it collects in between the two surfaces.

### SUMMARY

An example embodiment is directed to a method of fabricating a one-piece pad for supporting a portion of a vessel hull thereon. The method includes creating a product design in software for a mold. Creating the product design further includes forming a generally flat planar member portion representative of an upper surface of the to-be-formed one-piece pad, forming raised longitudinally elongated features in spaced-apart relation on a facing surface of the planar member which extend substantially upward from one side to the other side of the planar member, where the elongated features are configured to contact a surface portion of the vessel hull as the hull is to adapted to be supported by one of a stand, jack screw and trailer with the to-be-formed one-piece pad thereon, forming a backing plate portion with support ribbing representative of a bottom surface of the to-be-formed one-piece pad, and forming vertical sides around a circumference thereof between the planar member and backing plate portions to provide for moisture runoff. The method further includes forming a mold based on the created product design, mounting the mold on an injection molding machine, and forcing plastic materials into the mold on the injection molding machine to form the one-piece pad.

Another example embodiment is directed to a method of fabricating a one-piece pad for supporting a portion of a vessel hull thereon. In the method, a product design for a mold is created in software. Creating the product design further includes forming an upper planar surface portion with a plurality of ribs in spaced-apart relation there across and which extend substantially upward, where the ribs serve as contact points to a surface portion of the vessel hull adapted to be supported by a structure supporting the to-be-formed one-piece pad thereon, forming a rear support ribbing portion representative of a bottom surface of the to-be-formed one-piece pad, and forming vertical sides between the upper planar surface portion with ribs and rear support ribbing portion. The method further includes forming a mold based on the created product design, mounting the mold on an injection molding machine, and forcing plastic materials into the mold on the injection molding machine to form the one-piece pad.

Another example embodiment is directed to a method of fabricating a one-piece pad for supporting a portion of a water-borne or aircraft vessel hull thereon. In the method, a product design for a mold is created in software. Creating the product design further includes forming an upper planar surface portion with integral vertical sides around a periphery thereof of the to-be-formed one piece pad. In forming the planar surface portion, raised longitudinally elongated features are formed in spaced-apart relation there across which extend substantially upward. Spacings between the formed raised elongated features are configured as a plurality of spaced channels providing for moisture runoff along the integral sides. Creating the product design in software further includes forming a rear support ribbing portion representative of a bottom surface of the to-be-formed one-piece pad. The method further includes forming a mold based on the created product design, mounting the mold on an injection molding machine, and forcing plastic materials into the mold on the injection molding machine to form the one-piece pad.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a flowchart illustrating the method of fabricating the pad according to the example embodiment.

FIG. 2 is a flowchart illustrating functions of creating a product design in software for a mold in more detail.

FIG. 3 is a perspective view of the one-piece pad formed by the process of FIGS. 1 and 2 to illustrate the raised longitudinally elongated features and vertical sides in more detail.

FIG. 4 is a top view of the one-piece pad formed by the process of FIGS. 1 and 2 to illustrate the raised longitudinally elongated features and aperture penetrations in more detail.

FIG. 5 is a bottom view of the one-piece pad formed by the process of FIGS. 1 and 2 to illustrate the structural ribbing features and aperture penetrations in more detail.

### DETAILED DESCRIPTION

As to be described hereafter, the example embodiment is directed to a method of fabricating a one-piece pad for supporting a portion of a vessel hull thereon. The pad may be fabricated as a single item from a synthetic material (i.e., thermoplastic, rubber or similar material) from a mold in any desired shape (e.g., round, oval, rectangular or square).

The fabrication of a one-piece pad for supporting a portion of a vessel hull thereon represents a significant reduction in production costs over two-piece, rubber pad to hard backing plate assembly. Moreover, the one-piece pad design eliminates previous issues with moisture seepage between the pad and backing plate surfaces which led to accelerated erosion and wear.

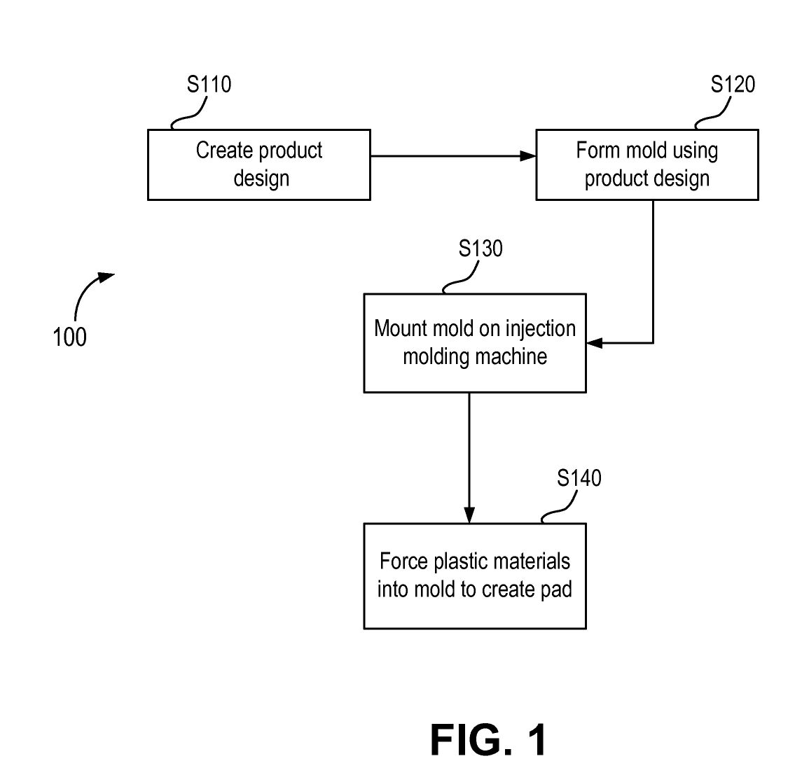

Referring now to FIGS. 1-5, a method 100 of fabricating a one-piece pad for supporting a portion of a vessel hull thereon includes creating a product design (S110) in software for a mold. As known, any CAD software design may be used to create the product design from which the mold is to be formed. One example is SOLIDWORKS®. Creating the product design involves developing a number of specific design features in software from which machining centers create the mold.

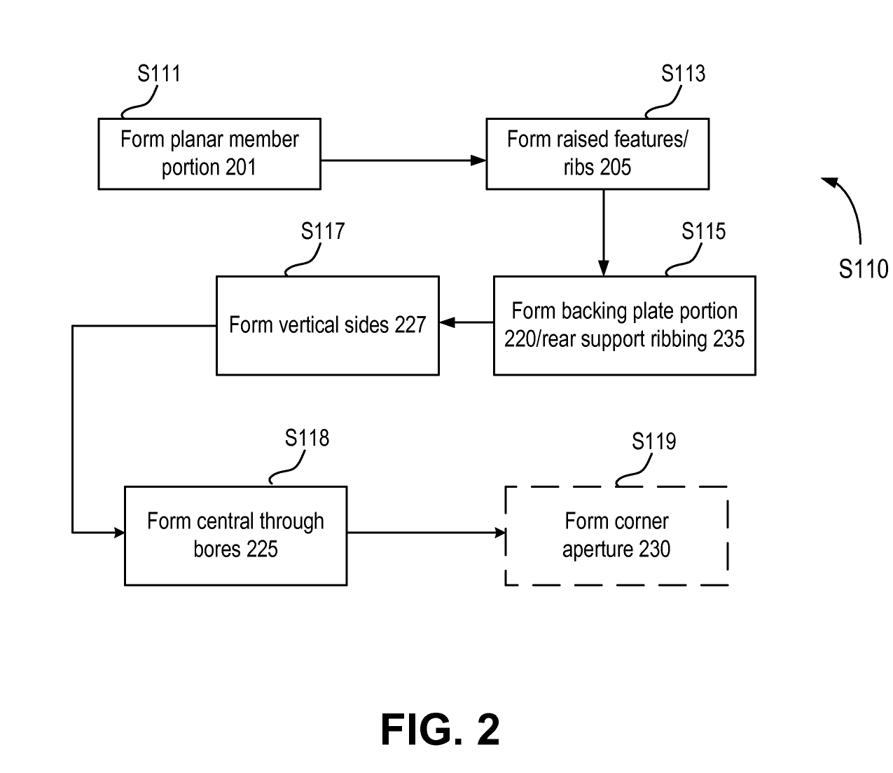

FIG. 2 is a flowchart illustrating functions of creating a product design in software for a mold in more detail. Creating the product design at S110 for the one-piece pad includes the following. Design of these product design features may be done by the designer in no particular order, in software, to include forming a planar member portion (S111), which may be generally flat and generally square or rectangular in shaped form, the planar member portion representative of an upper or top surface of the to-be-formed one-piece pad; and forming raised longitudinally elongated features in spaced-apart relation (S113) on a facing surface thereof which extend substantially upward from one side to the other side of the planar member portion. The elongated features are configured to contact a surface of the vessel hull as the hull is to be supported by structure having the pad thereon. The supporting structure may be embodied as a stand, jack screw or trailer including to-be-formed one-piece pad attached and/or affixed to a surface thereon.

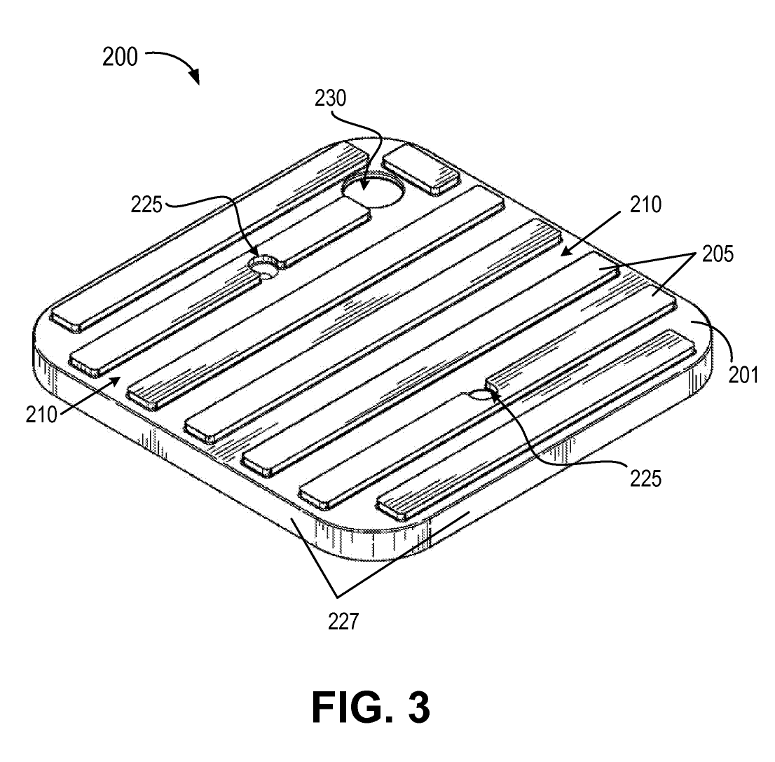

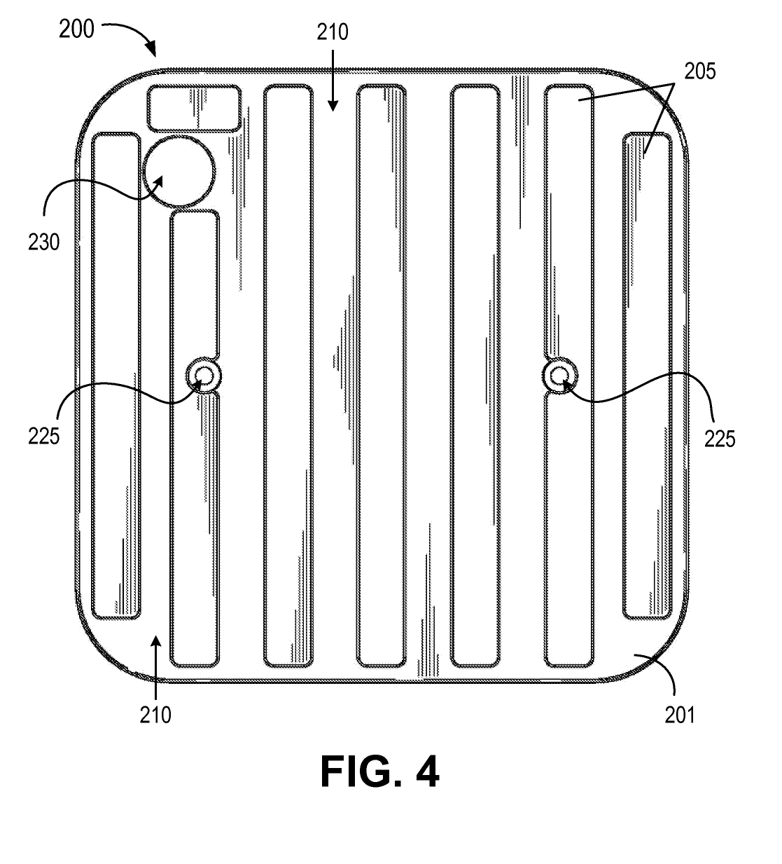

Steps S111 and S113 can be seen best by the formed one-piece pad 200 in FIGS. 3 and 4, in which a generally flat, square or rectangular shaped planar member portion 201 (upper surface or portion) includes a plurality of raised features or ribs 205 thereon. Ribs 205 may be arranged in parallel in adjacent spaced relation on a facing surface of the planar member portion 201 so as extend longitudinally along its facing surface, as shown in FIGS. 3 and 4. This arrangement defines a plurality of spacings or recesses which represent channels 210 there between. The channels 210 permit any moisture to runoff sides of pad 200.

The next steps in the creating product design at S110 may also include forming a backing plate portion (S115) with rear support ribbing representative of a bottom portion of the to-be-formed one-piece pad, and forming vertical sides around a circumference thereof (S117) between the planar member and backing plate portions to provide for moisture runoff.

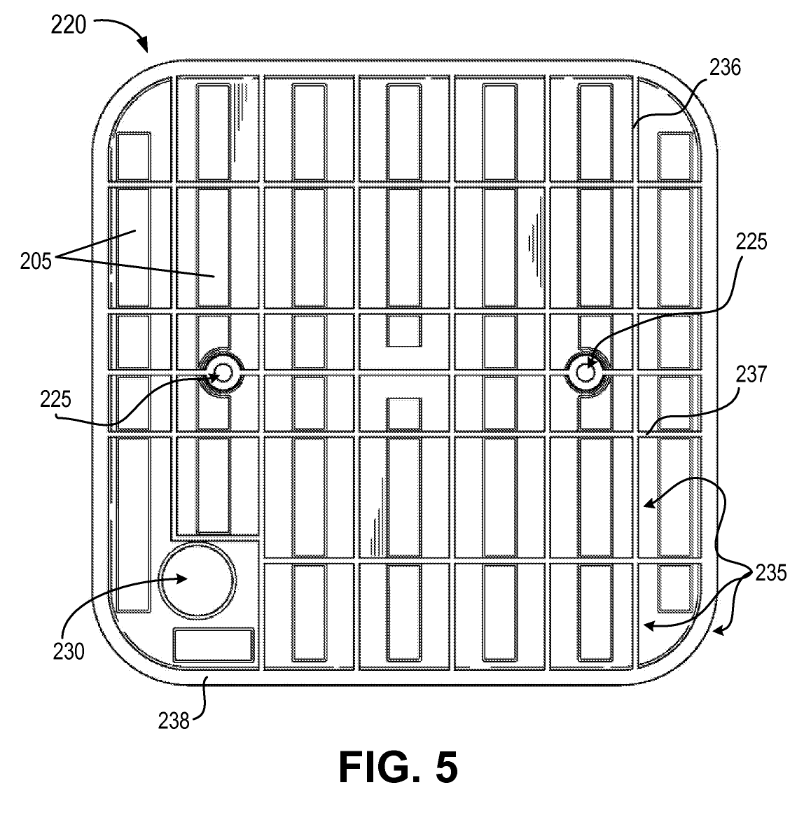

As to step S115, and as best shown in FIG. 5, forming the backing plate portion 220, which serves as the bottom surface of the pad 200, may further include designing in of forming a plurality of rear support ribbing, generally shown by arrows 235 in FIG. 5. The plurality of interconnected rear support ribbing 235 collectively may also be understood as representing the bottom surface of pad 200, as collectively the plurality of formed rear support ribbing 235 comprise the backing plate portion 220.

In FIG. 5, forming the rear support ribbing 235 may comprise designing or forming vertical cross bracing 236 and horizontal cross bracing 237, as well as designing or forming a foot support trim bracing 238 around the bottom outer circumference of the to-be-formed pad 200, which has a wider diameter than the bracings 236, 237 for additional support. The bottom surface comprised of this plurality of rear support ribbing 235, or the backing plate portion 220, is designed to seat or mate against a structure supporting the to-be-formed one-piece pad 200 thereon. Examples of this support structure may be an upper planar portion or surface of a stand, jack screw, or trailer, for example.

Additionally from FIG. 5 it can be seen that the interior of the ribs/raised features 205 are hollow, and truncated on the underside of planar member portion 201 by where the cross bracings 236, 237 cross or intersect a given rib/raised feature 205. The cross bracings 236, 237 are integrally molded into pad 200 between the underside of the planar member portion 201 and the bottom of the backing plate portion 220, meeting foot support trim bracing 238.

As to step S117 and as best shown in FIGS. 3 and 4, the vertical sides 227 are integrally arranged formed as vertical edge surfaces between the planar member portion 201 and backing plate portion 220. Any moisture present in channels 210 runoff the sides 227, as the pad 200 is typically canted at an angle against a portion of a vessel hull, such as a water-borne craft or aircraft.

Creating the product design at 5110 for the mold also includes designing or forming centrally located through bores 225 (S118) adapted to receive mechanical fasteners such as clamp bolts, so as to fixedly secure the pad 200 to an upper planar portion or surface of a stand, jack screw or trailer. The aspect of a vessel hull pad secured to a stand, jack screw or trailer is described in FIGS. 3-6 of the inventor's '726 patent; for purposes of brevity the corresponding figures and supporting description are omitted herein.

Optionally, creating the product design at 5110 can include forming a corner aperture (S119) (shown in dotted line), such as aperture 230 shown in any of FIGS. 3-5. Aperture 230 may be provided or designed in software in a corner of the product design used for forming the mold to create pad 200. Aperture 230 may be provided for ease of adjustment of stand/trailer/jack screw height. As this is also described in detail in FIGS. 3-6 of the inventor's '726 patent, a detailed explanation is omitted for purposes of brevity.

Referring again to FIG. 1, method 100 includes forming the mold (S120) based on the created product design. This is done by machining centers for example, as is known. The formed mold is then mounted on an injection molding machine (S130), and plastic materials are forced into the created mold on the injection molding machine (S140) to form the one-piece pad 200 that is shown in FIGS. 3-5.

Pad 200, with its reinforced backing portion 220 comprising the rear support ribbing 235 is thus a departure from the multi-piece assembly of the inventor's previous efforts. Further, pad 200 may be ultraviolet and chemical resistant and composed of an elastomeric, rubber or like material. As examples, pad 200 may be composed of a thermoplastic elastomer, a thermoplastic with or without UV inhibitors, combinations of these materials, a rubber, etc.

Pad 200 has been described as being formed by an injection molded process. Example processes may include over-molding, insert molding, co-injection molding, etc. The forming process for pad 200 is not limited to injection molding as other manufacturing methods known to one having ordinary skill in the art, such as a compression process and/or an extrusion process may be used to form the single pad 200.

The example pad 200 may be designed to protect a vessel hull bottom from scratches, blemishes, rub marks and damage and to prevent moisture from being held against the vessel hull bottom due to the raised features or ribs 205, for example, which limits the amount of surface area of the pad 200 that actually contacts the vessel hull. Pad 200 is configurable for use in conjunction with or on boat trailers and stands and screw jacks, and may be applied equally to vessel hulls for supporting water borne vessels such as watercraft/boat hulls, as well as airplane hull vessels.

Additionally, the pad 200 configuration provides channels 210 which may allow any moisture to drain off the pad 200. Moreover as described above, as this reinforced pad 200 is formed in a one-piece construction with no seams or gaps, with seamless vertical sides 227 in additional to the channels 210, there is no opportunity for residual moisture to seat between separate pad/backing plate surfaces.

The example embodiments being thus described, it will be obvious that the same may be varied in many ways. Such variations are not to be regarded as departure from the example embodiment, and all such modifications as would be obvious to one skilled in the art are intended to be included herein.

What is claimed:

1. A method of fabricating a one-piece pad for supporting a portion of a vessel hull thereon, comprising:
creating a product design in software for a mold, wherein creating the product design further includes:
forming a generally flat planar member portion representative of an upper surface of the to-be-formed one-piece pad,
forming raised longitudinally elongated features in spaced-apart relation on a facing surface of the planar member which extend substantially upward from one side to the other side of the planar member, the elongated features configured to contact a surface portion of the vessel hull as the hull is to adapted to be supported by one of a stand, jack screw and trailer with the to-be-formed one-piece pad thereon,
forming a backing plate portion with support ribbing representative of a bottom surface of the to-be-formed one-piece pad, and
forming vertical sides around a circumference thereof between the planar member and backing plate portions to provide for moisture runoff,
forming a mold based on the created product design,
mounting the mold on an injection molding machine, and
forcing plastic materials into the mold on the injection molding machine to form the one-piece pad.

2. The method of claim 1, wherein forming a backing plate portion with support ribbing further includes:
forming vertical cross bracing,
forming horizontal cross bracing, and
forming foot support trim bracing around a bottom outer circumference of the to-be-formed pad, the vertical and horizontal cross bracing integrally formed between an underside surface of the planar member portion and the foot support trim bracing.

3. The method of claim 1, wherein creating the product design further includes forming centrally located bores through the planar member and backing plate portions that are adapted to receive mechanical fasteners.

4. The method of claim 1, wherein creating the product design further includes forming a corner aperture through the planar member and backing plate portions to interface with one of stand, jack screw and trailer so as to provide for adjustment of one of stand, jack screw and trailer height with the formed pad thereon.

5. A method of fabricating a one-piece pad for supporting a portion of a vessel hull thereon, comprising:
creating a product design in software for a mold, wherein creating the product design further includes:
forming an upper planar surface portion with a plurality of ribs in spaced-apart relation there across and which extend substantially upward, the ribs serving as contact points to a surface portion of the vessel hull adapted to be supported by a structure supporting the to-be-formed one-piece pad thereon,
forming a rear support ribbing portion representative of a bottom surface of the to-be-formed one-piece pad, and
forming vertical sides between the upper planar surface portion with ribs and rear support ribbing portion,
forming a mold based on the created product design,
mounting the mold on an injection molding machine, and
forcing plastic materials into the mold on the injection molding machine to form the one-piece pad.

6. The method of claim 5, wherein forming the rear support ribbing portion further includes:
forming vertical cross bracing,
forming horizontal cross bracing, and
forming foot support trim bracing around a bottom outer circumference of the to-be-formed pad, the vertical and horizontal cross bracing integrally formed between an underside surface of the upper planar surface portion and the foot support trim bracing.

7. The method of claim 5, wherein creating the product design further includes forming centrally located bores through the upper planar surface and rear support ribbing portions that are adapted to receive mechanical fasteners.

8. The method of claim 5, wherein creating the product design further includes forming a corner aperture through the upper planar surface and rear support ribbing portions to interface with one of stand, jack screw and trailer so as to provide for adjustment of one of stand, jack screw and trailer height with the formed pad thereon.

9. A one-piece pad for supporting a portion of a vessel hull, comprising a pad formed by the method of claim 1.

10. The pad of claim 9, wherein the pad is configured to support the vessel hull of a water-borne craft or aircraft.

11. A one-piece pad for supporting a portion of a vessel hull, comprising a pad formed by the method of claim 5.

12. The pad of claim 11, wherein the pad is configured to support the vessel hull of a water-borne craft or aircraft.

13. A method of fabricating a one-piece pad for supporting a portion of a water-borne or aircraft vessel hull thereon, comprising:
creating a product design in software for a mold, wherein creating the product design further includes:
forming an upper planar surface portion with integral vertical sides around a periphery thereof of the to-be-formed one piece pad, forming the planar surface portion further including forming raised longitudinally elongated features in spaced-apart relation there across which extend substantially upward, spacings between the raised elongated features configured as a plurality of spaced channels providing for moisture runoff along the integral sides,
forming a rear support ribbing portion representative of a bottom surface of the to-be-formed one-piece pad, and
forming a mold based on the created product design,
mounting the mold on an injection molding machine, and
forcing plastic materials into the mold on the injection molding machine to form the one-piece pad.

14. The method of claim 13, wherein forming the rear support ribbing portion further includes:
forming vertical cross bracing,
forming horizontal cross bracing, and
forming foot support trim bracing around a bottom outer circumference of the to-be-formed pad, the vertical and horizontal cross bracing integrally formed between an underside surface of the upper planar surface portion and the foot support trim bracing.

15. The method of claim 13, wherein creating the product design further includes forming centrally located bores through the upper planar surface and rear support ribbing portions that are adapted to receive mechanical fasteners.

16. The method of claim 13, wherein creating the product design further includes forming a corner aperture through the upper planar surface and rear support ribbing portions to interface with one of stand, jack screw and trailer so as to provide for adjustment of one of stand, jack screw and trailer height with the formed pad thereon.

17. A one-piece pad for supporting a portion of a water-borne or aircraft vessel hull thereon, comprising a pad formed by the method of claim 13.
